(19) United States
(12) Patent Application Publication
(10) Pub. No.: US 2021/0312371 A1
(43) Pub. Date: Oct. 7, 2021

(54) Passive Time Cost Accounting System

(71) Applicant: Field Squared, Inc., Denver, CO (US)

(72) Inventor: Jason Doherty, Denver, CO (US)

(21) Appl. No.: 14/483,152

(22) Filed: Sep. 11, 2014

Related U.S. Application Data
(60) Provisional application No. 61/877,571, filed on Sep. 13, 2013.

(51) Int. Cl. G06Q 10/06; G06Q 10/08; H04W 64/00; H04W 4/029

(52) U.S. Cl. CPC G06Q 10/063114; G06Q 10/0875; G06Q 10/0833; H04W 4/029; H04W 64/006

(57) ABSTRACT

The preferred embodiment of invention utilizes GPS functionality integrated within the physical apparatus and operating systems utilized by mobile smart phones and tablets utilizing Apple iOS and Android OS operating systems and other computers to determine where and when a group of field workers are not moving or stationary during the workday by measuring where the device has decelerated and then stopped at a given location. Using the location data in this way, this “stop” data can be correlated against known latitude/longitude points for job sites and suppliers, and then used to account fully for the time spent on site and at suppliers by field workers during the day, as well as mileage per job and the number of side trips per job, without requiring the user to interact with the device during the workday. In this manner, the entire time allocation for a given field worker or set of field workers can be accounted for without requiring users to interact with the device at all. This same technique can be extended indoors using Wi-Fi hotspot correlation techniques to determine where an indoor set of workers are spending their time within a building.

### CROSS-REFERENCE TO RELATED APPLICATIONS

This application claims the benefit of U.S. Provisional Application No. 61/877,571, filed Sep. 13, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to the tracking of workers through the utilization of mobile operating systems and mobile devices utilizing GPS technologies and other applications and computers to enable improved management and oversight.

### BACKGROUND OF THE INVENTION

Business managers have often struggled to document and maintain an understanding of the location of workers and the time workers spend at a variety of site. Existing electronic solutions for field force management exhibit a number of shortcomings.

Such solutions known in the prior art include those that require workers to manually check into and check out of jobs on their devices by pushing buttons or executing other tasks. This process starts and stops a timer on the device that is then used to measure time on site. A problem associated with such solutions is that they enable workers to circumvent processes designed to track them, either intentionally or unintentionally, by neglecting to check into and out of jobs assigned to them.

Other location tracking solutions known in the prior art track where the user is moving. Computers and software associated with such solution record this movement in a system as a track of waypoints, typically in a “GPX” format. Such data is then used to track routes, mileage and traffic taken by a worker. A problem associated with waypoint-tracking systems is that while they record the tracks taken by workers, they do not calculate where users are spending their time.

Yet other solutions known in the prior art require installation of a physical device on the user's vehicle. Such devices are utilized to determine when the vehicle is turned on or off, moving or not moving, and therefore when the vehicle is stationary at a point. However, users may intentionally or unintentionally circumvent the mechanisms utilized by such devices by, for example, neglecting to turn off the vehicle at a stopped position.

The present inventor has recognized that the solutions to workforce tracking known in the prior art each have specific problems associated with efficiency and circumvention. Thus, a need exists to create a system to track workforce members in a more automated, less easily circumvented and generally more effective manner.

### SUMMARY

The preferred embodiment of the present invention utilizes the Global Positioning System (“GPS”) functionality utilized in mobile smart phones and tablets, specifically those mobile smart phones and tablets utilizing the Apple iOS and Android OS operating systems, to determine where a group of field workers are not moving or stationary during the workday. Such embodiment harnesses the GPS and integrated operating system functionalities of Apple iOS and Android OS devices to determine where such devices have decelerated and then stopped at a given location. Utilizing location data in this way, such “stop” data can be correlated against known latitude/longitude points for job sites and suppliers, and then utilized to account fully for the time spent on site and at suppliers or other work-relevant locations by workers during the workday. The preferred embodiment also determines mileage per job and the number of detours taken per job, without requiring the user to interact with device during the workday.

In this manner, the entire time allocation for a given worker or set of workers is determined by the preferred embodiment of the invention without requiring users to interact with the mobile device to track location or time, or providing opportunity for users to circumvent tracking mechanisms intentionally or unintentionally, thus solving a previously unmet need associated with workforce tracking.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing a passive time cost accounting system.

FIG. 2 illustrates an example flowchart of various operations performed by the passive time cost accounting system disclosed herein.

FIG. 3 illustrates example of track data captured with 10 m accuracy and 45 m distance filtering.

FIG. 4 illustrates an example of track data of a vehicle looking for parking, then parked. The circle indicates a region in which the device tends to stay until it comes to rest. This is determined to be the “stop” location of the device.

FIG. 5 illustrates an alternative example of a real world captured data of a device coming to a stop at location on two separate locations during the same day, once for an hour, and once for 40 minutes. The “hovering” effect of the data clumping around the area and the user looking for parking is visible in this screen shot the tracking data. The patterns in the data when looking for parking, walking and driving are all different.

FIG. 6 illustrates an alternative example of a user arriving at a home center, parking, getting out of the car and then walking around the home center to pickup supplies for 10 minutes, getting back into their car, and then leaving. Total time on site was calculated as 25 minutes, even though the user wasn't stationary at all during that time and was carrying the device with them.

FIG. 7 illustrates an example map showing all stop locations calculated in the field for a team on a given day, solely using GPS tracking points captured on a smart device.

FIG. 8 illustrates an example report showing time cost accounting for each user for a given day based on GPS derived stop data.

FIG. 9 illustrates an example report of time spent on job sites broken down by user and time on site calculated from GPS derived tracking data.

FIG. 10 illustrates an example of breakdown report of total time spent by the team on different job types over a given work week, captured from users mobile phones out in the field.

FIG. 11 illustrates an example computing system that can be used to implement the communication system disclosed herein.

FIG. 12 illustrates an example mobile computing device that can be used to implement one or more components of the communication system disclosed herein.

FIG. 13A Example of a typical track that is recorded for a user driving in a straight line, recording changes every 50 meters.

FIG. 13B Example of a track where each point is evenly spaced from the previous point by the same distance and the points form a straight line. Because the device is decelerating, the time interval between one point and the next increases even though the distance stays the same.

FIG. 13C Example of a track where the points captured tend to not form in a straight line even when the user is driving in a straight line, due to inherent inaccuracies in real time GPS on mobile devices.

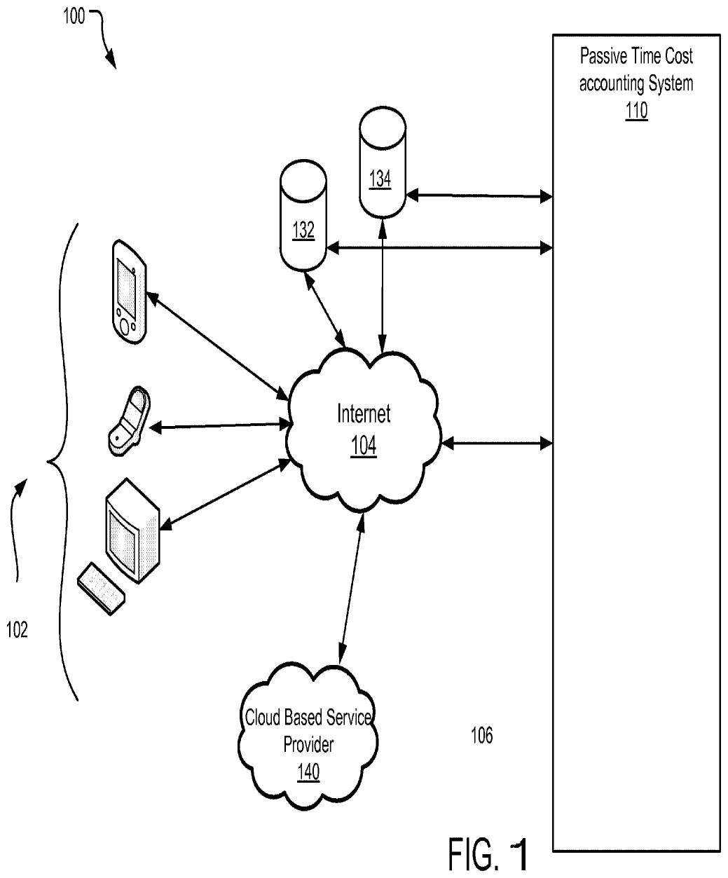

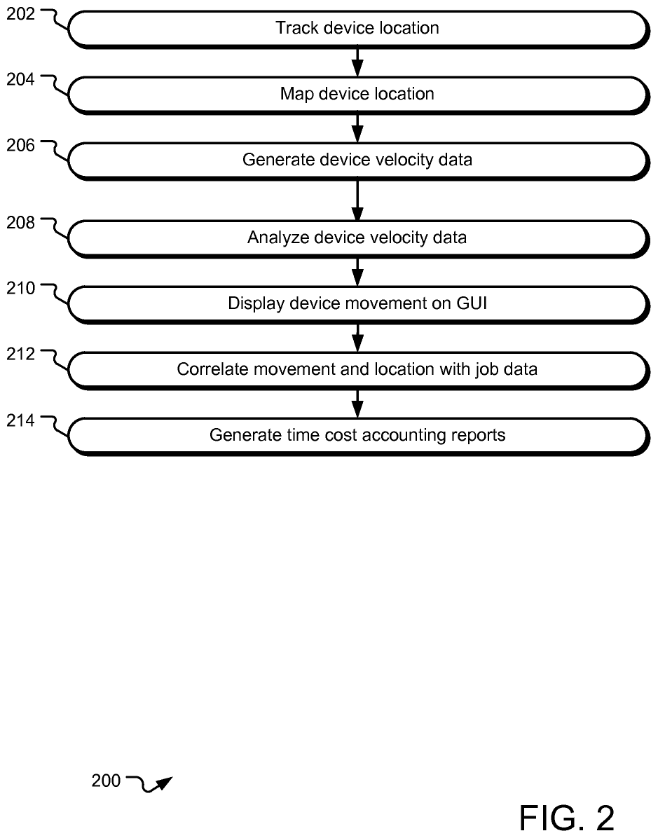

### DETAILED DESCRIPTION

The preferred embodiment of the invention incorporates an iOS or Android OS application to utilize the GPS features on devices running iOS or Android OS operating systems to track when such a device is not moving or has stopped. This is accomplished without any need for physical devices installed on vehicles to track user interaction or the user interacting with any smart device. The preferred embodiment of the invention utilizes the GPS tracking data (and optionally motion tracking data using the accelerometer integrated within a device running iOS or Android) generated from a smart phone or tablet running iOS or Android or a plurality of smart phones and tablets running iOS or Android to determine where field users are spending their time.

Embodiments of the invention will also function where a vehicle is not involved and workers carrying mobile devices are moving on foot (for example, canvassing during political elections). The stop data is used to perform point-to-point analysis against other known points of interest to determine where your field force is spending their time solely using the GPS in smart devices. The accelerometer, where available, can also be used to improve the detection of walking vs. driving, however this is not required in order for the application to function.

Using the stop data captured from the device and then correlating this with known job sites and supplier locations, office locations and user's home locations, the preferred embodiment of the present invention determines for a group of workers or for a single worker, without requiring the user to interact with the device, without limitation, the following items of information:

A measurement of time users are spending on site for each job;

A measurement of time elapsed of jobs of a given category; The number of deviations taken by workers during trips to suppliers for each job site;

A measurement of time spent by users while driving to get parts or collect supplies;

Where users are choosing inefficient ways to complete work on site;

Where users are choosing inefficient ways to purchase materials to complete a job;

Where users are arriving on time, early or late to their appointment time with a customer;

A measurement of total mileage driven by a worker for work-related tasks; A full-time based report and accounting of the day for each field workers, for the whole team, and for the whole company.

The preferred embodiment of the current invention generates reports that provide the above data points, deriving from information collected by iOS and Android mobile devices as further processed in the cloud. The data generated is then stored in a data store.

### Location Capture Using Standard GPS Devices

As location aware devices, including smart phones and tablets running the iOS and Android operating systems, move with location services enabled, they capture a series of points in response to the device moving or changing their heading. Where a gyroscope or accelerometer is available, the device may also submit changes in motion of the device. These points are sent through as notifications to the operating system that “the device has moved” along with the new location for the device, how fast the device was moving, and how accurate the current reading from the location services device (GPS, accelerometer, gyroscope or cell-tower triangulation) is.

Each application running on the mobile device, in the preferred embodiment, an iOS or Android device, is sent a notification that the device has moved along with the details described in the preceding paragraph. In the application comprising the preferred embodiment of the invention, the location data is aggregated up once a minute up into a Track Data package, which is similar in structure to the industry-standard GPX format. A Track Data package sent from the device to the server contains, without limitation:

A list of all tracking points recorded during that minute, including both the latitude, longitude and time stamp of that point;

The ID of the device or user sending that point;

A timestamp of when the data was sent; and

A unique message ID generated on the device, which is used to validate that the data package comprising the Track Data has been received by the server.

The data generated is then stored in a data store.

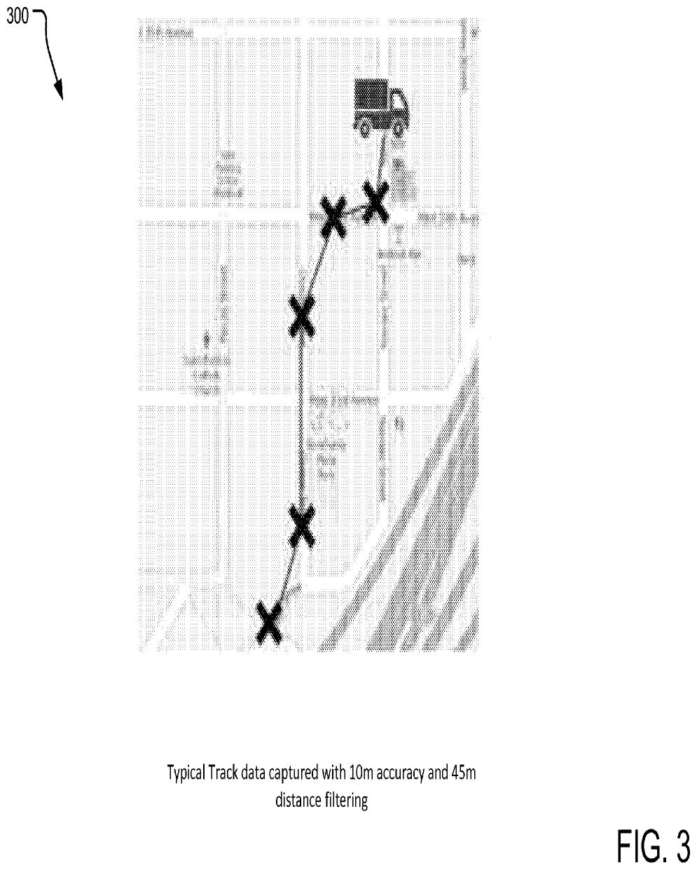

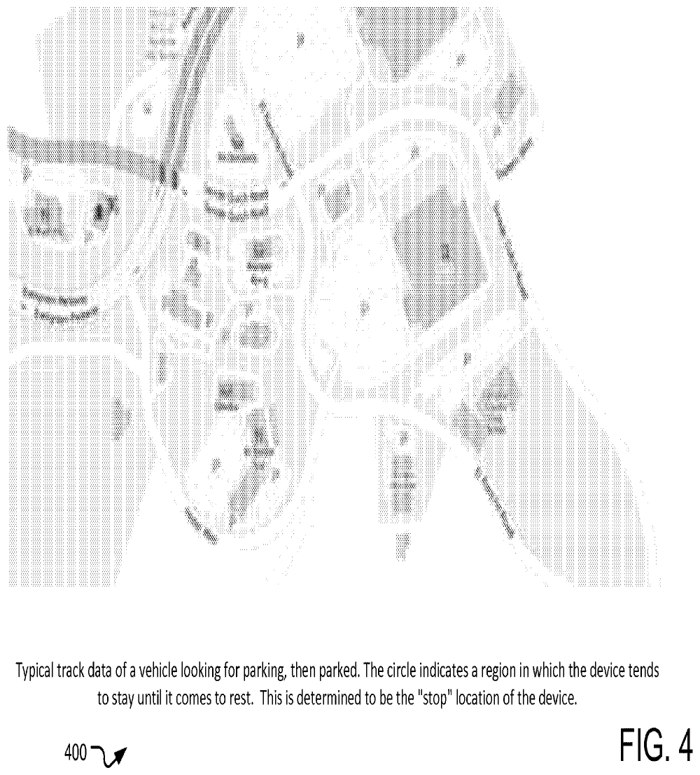

FIG. 3 shows a track captured with 10-meter accuracy where the device sent through tracking notifications every 45 meters of device movement. This map representation of tracking data is typical of most location tracking systems.

In the preferred embodiment, where the device stops sending through location change notifications for a period of 90 seconds, the device will aggregate any pending location tracking points that were recorded and will send them through to the server or cloud anyway, to record the last known locations of the device when it stopped recording data.

### Interpreting the Track Data to Find “Stops” or Time Spent at a Location

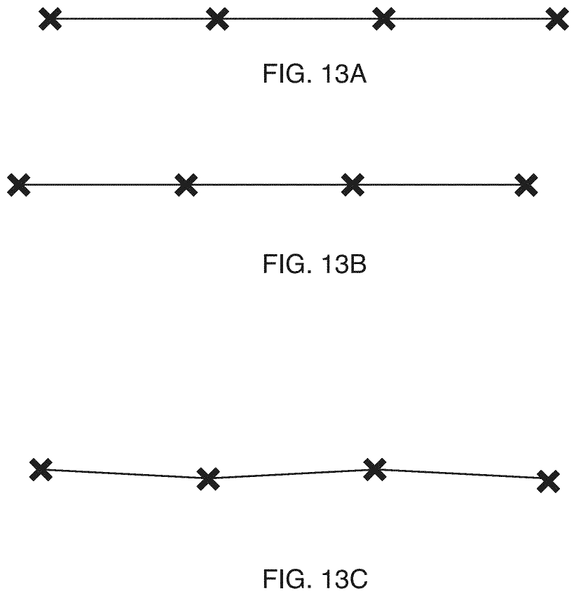

A typical track that is recorded for a user driving in a straight line, recording changes every 50 meters, while ignoring directional changes would look as shown in FIG. 13.a. under perfect conditions with a high degree of accuracy.

Each point is evenly spaced from the previous point by the same distance and the points form a straight line. Since the device is decelerating, the time interval between one point and the next increases even thought the distance stays the same, as shown in FIG. 13.b.

In reality, the points captured tend to not form in a straight line, even when the user is driving in a straight line, due to the inherent inaccuracies in real-time GPS on mobile devices, as depicted FIG. 13.c.

Since GPS is not perfectly accurate, mobile devices utilizing GPS technologies tend to generate location that is “fuzzy” in nature, insofar as it typically represents an approximation of where the user is at a given time in space. It is the fuzzy and approximate nature of the location data combined with the time stamps recorded for each track point received that are used to determine where users are stopped in the preferred embodiment of the invention.

The preferred embodiment of the present invention determines the following events, without limitation, by examining patterns in the track data where track data of a given time period tends to “clump” or be space-time consistent, on average, around the same location, for a given time period:
Where the device is in a vehicle where the vehicle operator is seeking parking, then stops;
Where a device is in a vehicle pulling into a parking space, then becomes stationary;
Where a device is in a vehicle that has parked, and the user picks up the device and carries it, which can be determined both with the GPS alone and the GPS and accelerometer/gyroscope together;
When the device is in a vehicle where the vehicle operator is seeking parking;
When the device is transitioning from being in a vehicle that is moving in a straight line or through curvy roads, or through city blocks, to where that device is being picked up and carried into a job site.

Each of these events leaves a “signature” of space-time data collection in the track data that can be used to determine that the device is currently on site at a given latitude/longitude location of a known site. The data generated is then stored in a data store.

Example: when the device in a vehicle that is driving around while the driver is looking for a place to park, the data tends to hover around a certain point with sharp transitions in the track vectors, where track vectors are described as large changes in heading. The device will be moving at a slow velocity. Eventually the data will stop (in terms of time) for a period of more than 5 minutes.

The preferred embodiment of the present invention utilizes software algorithms to seek patterns in the space-time distribution of the location tracking points sent through to the server to determine the location at which a device has stopped. Such embodiment of the invention determines average location of a device that is moving while remaining at approximately the same location over a given time period. The algorithm associated with the preferred embodiment of the invention determines data that aggregates in a close proximity for given location for a minimum time period as a moving average. For example, the algorithm may determine that a device has moved at a velocity of less than 15 miles per hour within 500 yards of a single location point within a 10 minute period to categorize data as aggregated in close proximity.

Eventually the device will stop sending data after this has occurred if the device is left in the vehicle. Alternatively, the device will send small amounts of data if the user is carrying the device around while walking. This is deemed to be the stop location. Sometimes the device will decelerate quickly and come to a stop, and not move for a while. This is also determined to be a stop event, even though the device wasn't hovering around a given point for a while.

Eventually the device will accelerate and start moving again at speeds that are consistently moving away from the stop location, and this will indicate that the stop event has completed. The server or cloud connected computer analyzes all track data and calculates for each user carrying a device, without limitation:

when the device stopped, for how long, and provides this data back to the devices themselves; and

the output is produced on the devices as maps.

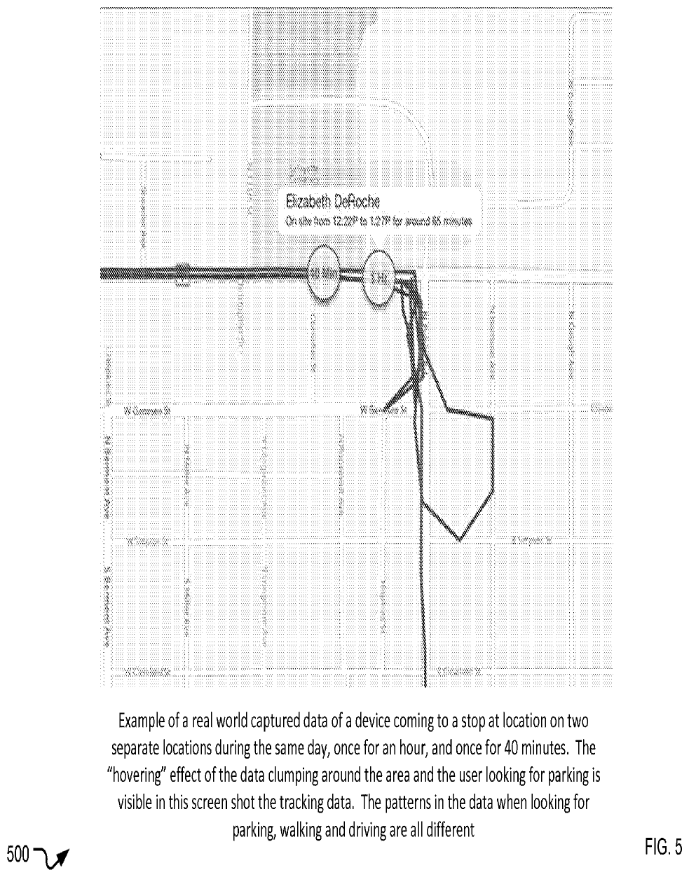

Example of a real world captured data of a device coming to a stop at location on two separate locations during the day, once for an hour, and once for 40 minutes, is shown in FIG. 5. The “hovering” effect of the data clumping around the area and the user looking for parking is visible in this screen shot the tracking data. The patterns in the data when looking for parking, walking, and driving are all different.

The stop data provides information on where a worker or plurality of workers have spent their time throughout the day. The preferred embodiment of the present invention calculates and displays data correlating to where said worker or plurality of workers were not moving.

### Correlation of Stop Data Against Jobs and Known Points of Interest

The stop data collected by the device and provides a useful summary of, without limitation:

When the device was stopped throughout the day;

where the device was when it stopped as a latitude/longitude location; and

how long the device was stopped.

The data generated is then stored in a data store.

For each job assigned to a worker carrying a mobile device, the job has a street address recorded against it. This address is run through industry standard geocoding engines to provide a latitude and longitude to represent the location on a map of this address. For example:

Job Address=3408 Navajo St, Denver Colo.

Geocoder Returns: latitude=39.764637, longitude=−105.004104

The data generated is then stored in a data store.

Each job assigned to a worker may have an additional list of service addresses at which a worker perform work in association with the job. Embodiments of the invention also may incorporate a list of all materials suppliers and vendors by default (for example, home centers, plumbing suppliers, garden centers) and their street addresses and GPS locations.

In all cases, anything with an address can be analyzed and compared against the stop data.

The GPS location of the stop data for each user is then compared to the GPS location of each type of address, which includes, without limitation:

Each job address;

each customer address and each service address for a customer;

each supplier;

the home location for the user; and

the office locations for the business using the software.

We then compare the list of latitude/longitude coordinates for jobs, points of interest, customers, suppliers, offices etc. to the list of stop points using standard spatial analysis techniques for comparing distances with GPS data. The data generated is then stored in a data store.

If a worker stops at a GPS location (latitude/longitude), as captured from the device GPS data is within a user definable distance of an address we are tracking in our address database, the device is deemed to be “at that address” for the duration of the stop time and the time from the users day is allocated against that job, customer, service address, supplier, home location or office location.

The server or cloud-connected computer calculates the order of tracked locations visited during each day. The order of tracked location is then stored in a data store. Utilizing this ordering of track data, the preferred embodiment of the invention calculates, without limitation:

The duration of each job;

the number of side trips taken by the worker to suppliers to complete a job;

the duration of time a worker spends on-site at suppliers;

the duration of time spent driving to suppliers; and

a metric of the overall efficiency of a worker getting a job done.

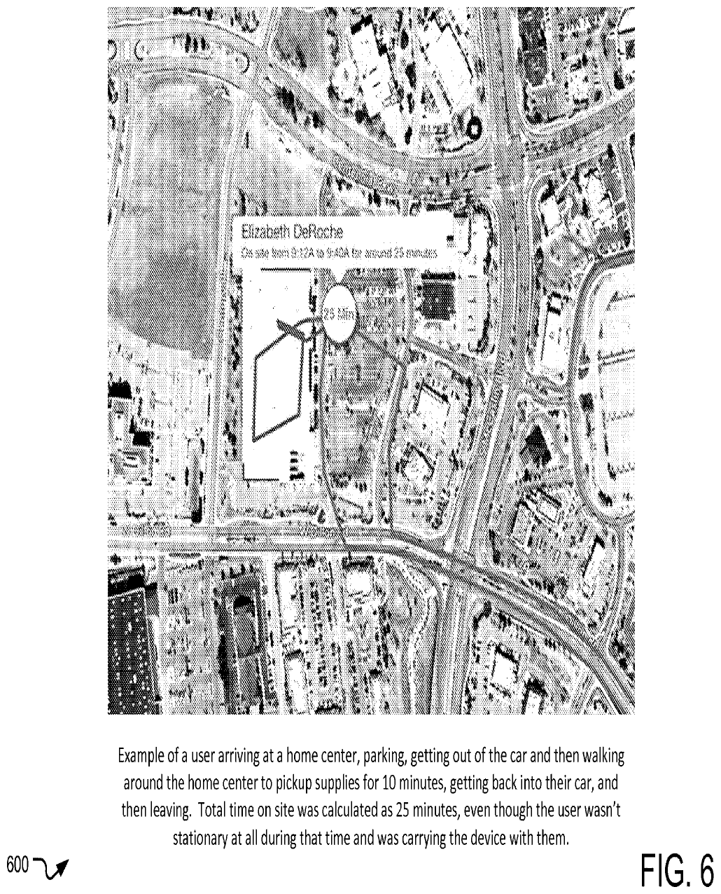

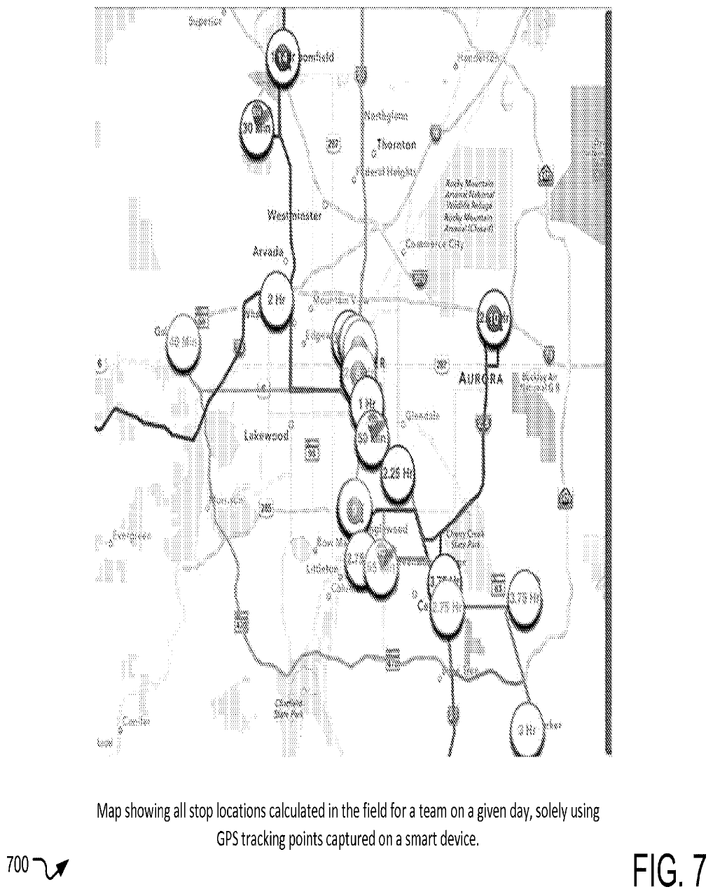

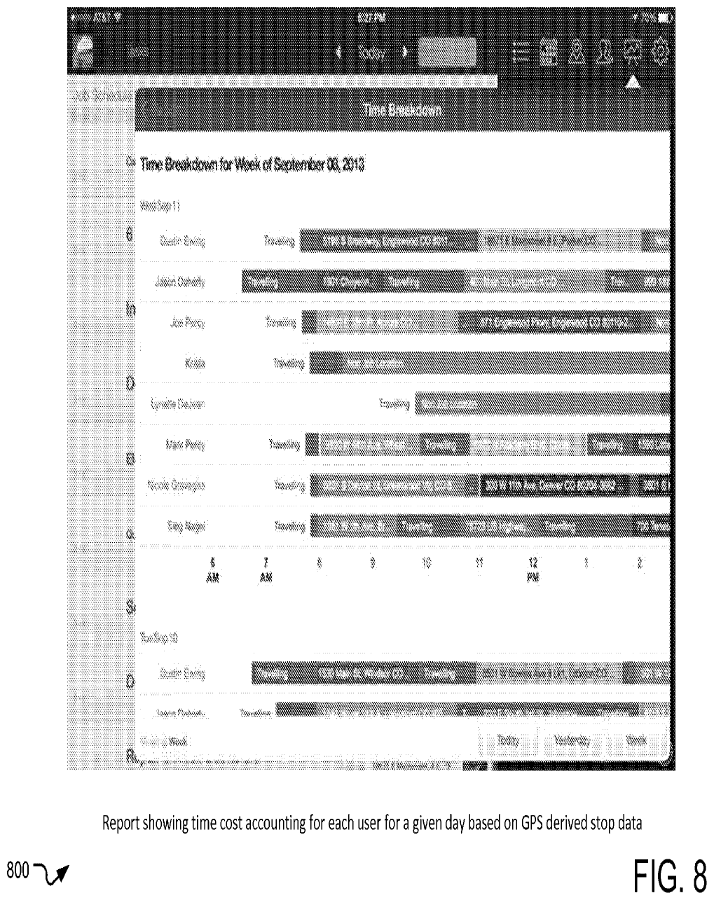

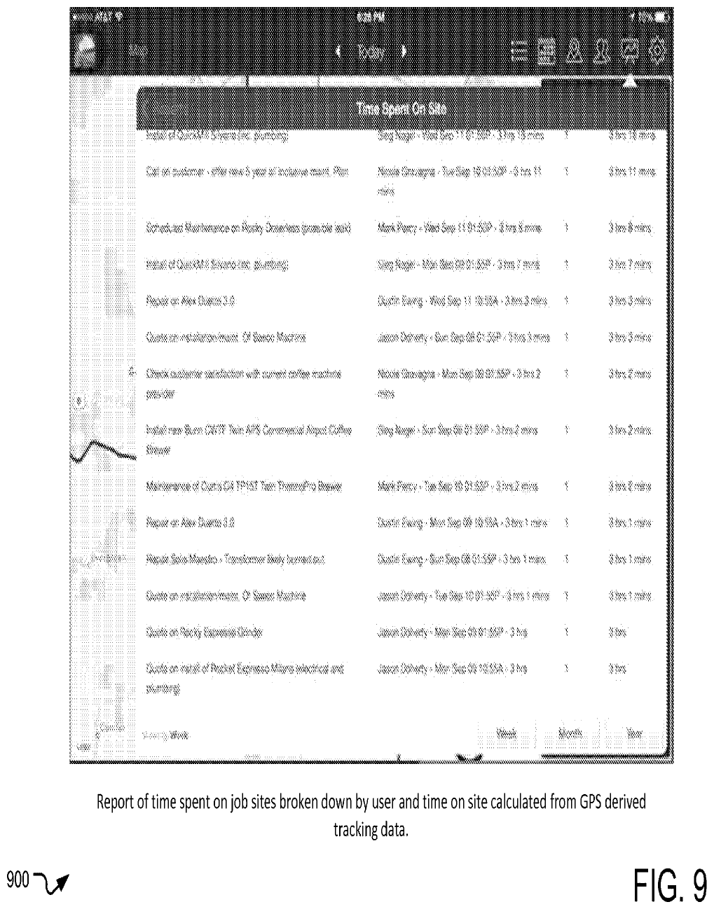

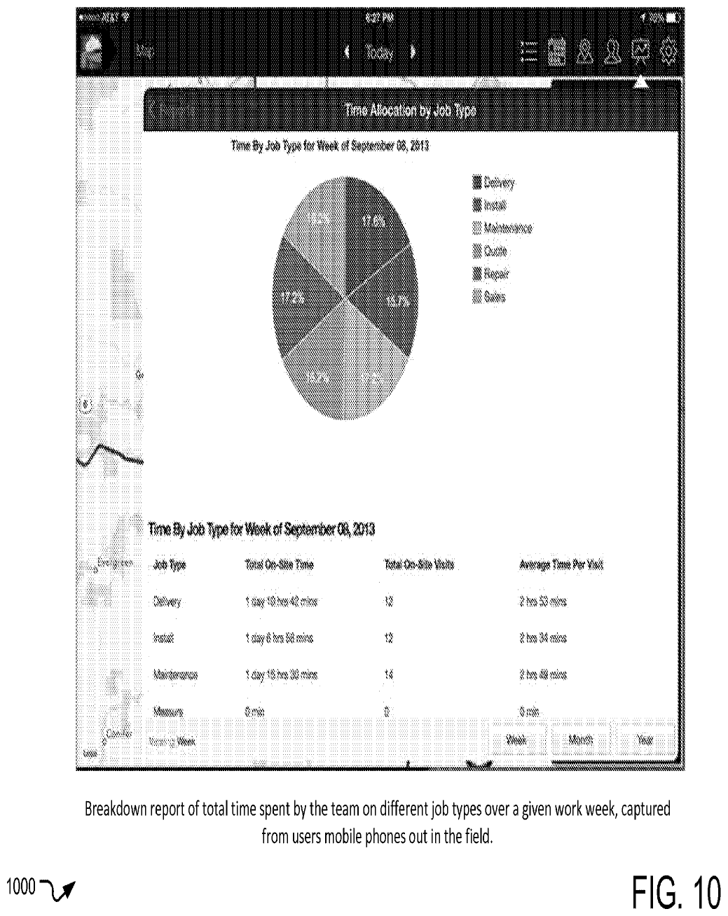

Example of a user arriving at a home center, parking, getting out of the car and then walking around the home center to pick up supplies for 10 minutes, getting back into their car, and then leaving, is shown in FIG. 6. Total time on site was calculated as 25 minutes, even though the user wasn't stationary at all during that time and was carrying the device with them.

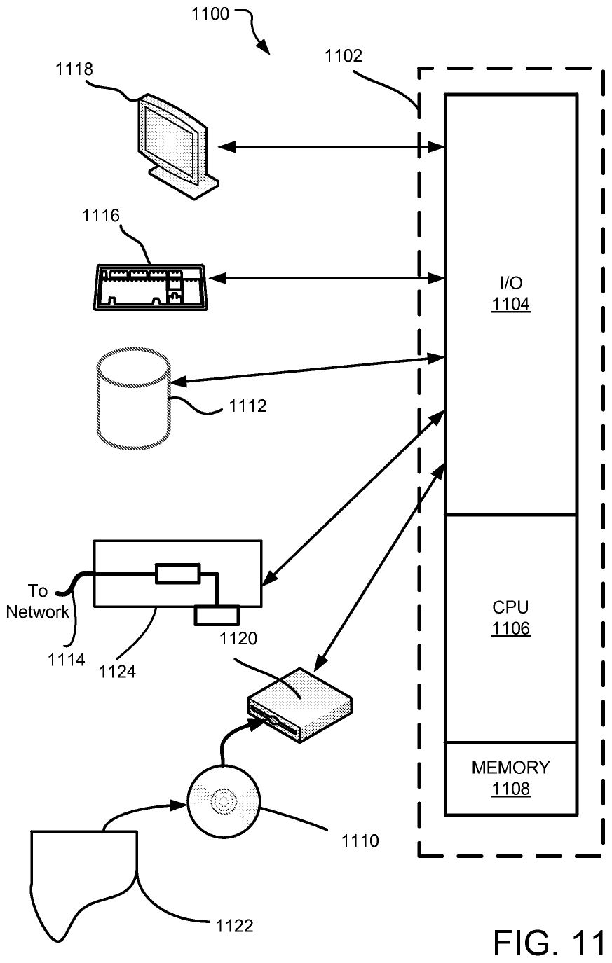

FIG. 11 illustrates an example computing system that can be used to implement one or more components of the communication system method and system described herein. A general-purpose computer system 1100 is capable of executing a computer program product to execute a computer process. Data and program files may be input to the computer system 1100, which reads the files and executes the programs therein. Some of the elements of a general-purpose computer system 1100 are shown in FIG. 11, wherein a processor 1102 is shown having an input/output (I/O) section 1104, a Central Processing Unit (CPU) 1106, and a memory section 1108. There may be one or more processors 1102, such that the processor 1102 of the computer system 1100 comprises a single central-processing unit 1106, or a plurality of processing units, commonly referred to as a parallel processing environment. The computer system 1100 may be a conventional computer, a distributed computer, or any other type of computer such as one or more external computers made available via a cloud computing architecture. The described technology is optionally implemented in software devices loaded in memory 1108, stored on a configured DVD/CD-ROM 1110 or storage unit 1112, and/or communicated via a wired or wireless network link 1114 on a carrier signal, thereby transforming the computer system 1100 in FIG. 11 to a special purpose machine for implementing the described operations.

The I/O section 1104 is connected to one or more user-interface devices (e.g., a keyboard 1116 and a display unit 1118), a disk storage unit 1112, and a disk drive unit 1120. Generally, in contemporary systems, the disk drive unit 1120 is a DVD/CD-ROM drive unit capable of reading the DVD/CD-ROM medium 1110, which typically contains programs and data 1122. Computer program products containing mechanisms to effectuate the systems and methods in accordance with the described technology may reside in the memory section 1104, on a disk storage unit 1112, or on the DVD/CD-ROM medium 1110 of such a system 1100, or external storage devices made available via a cloud computing architecture with such computer program products including one or more database management products, web server products, application server products and/or other additional software components. Alternatively, a disk drive unit 1120 may be replaced or supplemented by a floppy drive unit, a tape drive unit, or other storage medium drive unit. The network adapter 1124 is capable of connecting the computer system to a network via the network link 1114, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 1100 is connected (by wired connection or wirelessly) to a local network through the network interface or adapter 1124, which is one type of communications device. When used in a WAN-networking environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 1108 or other storage systems, such as disk storage unit 1112 or DVD/CD-ROM medium 1110 and/or other external storage device made available and accessed via a cloud computing architecture. Still further, some or all of the operations for the system for the communication system disclosed herein may be performed by the processor 1102. In addition, one or more functionalities of the system disclosed herein may be generated by the processor 1102 and a user may interact with these GUIs using one or more user-interface devices (e.g., a keyboard 1116 and a display unit 1118) with some of the data in use directly coming from third party web sites and other online sources and data stores via methods including but not limited to web services calls and interfaces without explicit user input.

A server 1206 hosts the system for communication system. In an alternate implementation, the server 1206 also hosts a website or an application that users visit to access the system for the communication system. Server 1206 may be one single server, or a plurality of servers with each such server being a physical server or a virtual machine or a collection of both physical servers and virtual machines. Alternatively, a cloud 1208 hosts one or more components of the system for the communication system. The user devices 1204, the server 1206, the cloud 1208, as well as other resources connected to the communications network 1202 access one or more of servers 1210, 1212, and 1214 for getting access to one or more websites, applications, web service interfaces, etc., that are used in the communication system. In one implementation, the server 1206 also hosts a search engine that is used by the system for accessing the system for the communication system and to select one or more services used in the communication system.

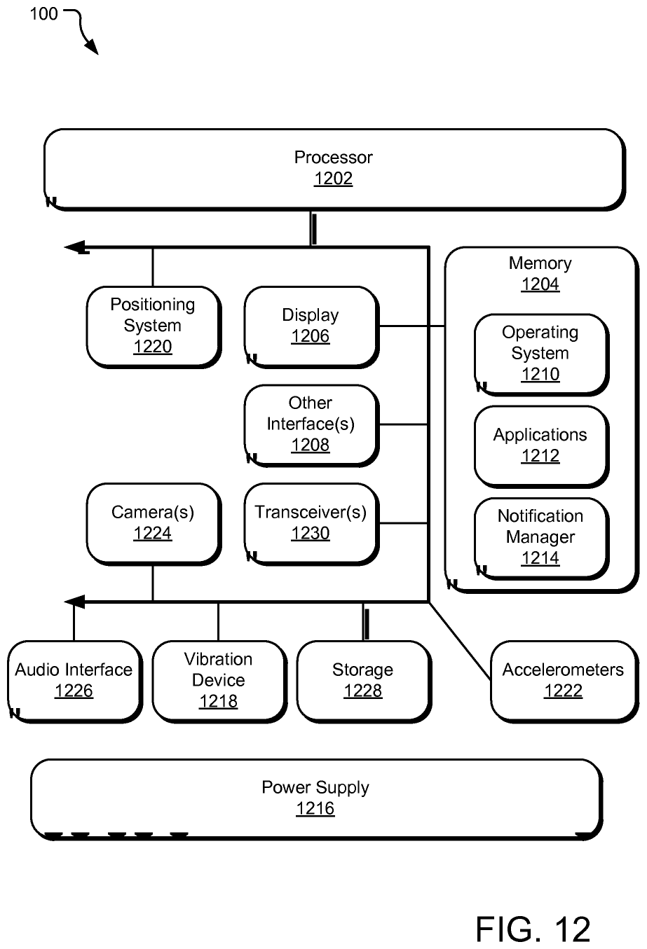

FIG. 12 illustrates an example mobile computing device 1200 that can be used to implement one or more components of the communication system disclosed herein. Specifically, the mobile computing device 1200. The mobile device 1200 includes a processor 1202, a memory 1204, a display 1206 (e.g., a touchscreen display), and other interfaces 1208 (e.g., a keyboard). The memory 1204 generally includes both volatile memory (e.g., RAM) and non-volatile memory (e.g., flash memory). An operating system 1210 resides in the memory 1204 and is executed by the processor 1202, although it should be understood that other operating systems may be employed. In the preferred embodiment of the invention, the operating system 1210 utilized is either the Apple iOS operating system or the Android OS operating system.

One or more application programs 1212 are loaded in the memory 1204 and executed on the operating system 1210 by the processor 1202. Examples of applications 1212 include without limitation email programs, scheduling programs, personal information managers, Internet browsing programs, multimedia player applications, etc. In one implementation, a communication system application stored in the memory 1204 may be used to catalog various observations stored on the mobile device 1200, such as e-mail addresses from the e-mail application of the mobile device, the contacts from a contact management application stored on the mobile device 1200, etc. In yet another implementation, a client application stored in the memory 1204 of the mobile device 1200 may generate queries using the information stored on the mobile device 1200, receive entity relation information from a server generating relations between various elements, and display updated observations to a user of the mobile device 1200. A notification manager 1214 is also loaded in the memory 1204 and is executed by the processor 1202 to present notifications to the user.

The mobile device 1200 includes a power supply 1216, which is powered by one or more batteries or other power sources and which provides power to other components of the mobile device 1200. The power supply 1216 may also be connected to an external power source that overrides or recharges the built-in batteries or other power sources.

The mobile device 1200 includes one or more communication transceivers 1230 to provide network connectivity (e.g., mobile phone network, Wi-Fi®, BlueTooth®, etc.). The mobile device 1200 also includes various other components, such as a GPS positioning system 1220 (e.g., a global positioning satellite transceiver), one or more accelerometers 1222, one or more cameras 1224, an audio interface 1226 (e.g., a microphone, an audio amplifier and speaker and/or audio jack), and additional storage 1228. Other configurations may also be employed.

Embodiments of the present technology are disclosed herein in the context of a worker tracking and communication system. In the above description, for the purposes of explanation, numerous specific details are set forth in order to provide a thorough understanding of the present application. It will be apparent, however, to one skilled in the art that the present application may be practiced without some of these specific details. For example, while various features are ascribed to particular embodiments, it should be appreciated that the features described with respect to one embodiment may be incorporated with other embodiments as well.

By the same token, however, no single feature or features of any described embodiment should be considered essential to the application, as other embodiments of the application may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present application, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present application, the components, processes and/or data structures may be implemented using machine language, assembler, C or C++, Java and/or other high level language programs running on a data processing computer such as a personal computer, workstation computer, mainframe computer, or high performance server running an as such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple as OSX-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present application, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the application. Although various embodiments of the application have been described above with a certain degree of particularity, or with reference to one or more individual embodiments, those skilled in the art could make numerous alterations to the disclosed embodiments without departing from the spirit or scope of this application. In particular, it should be understood that the described technology may be employed independently of a personal computer. Other embodiments are therefore contemplated.

It is intended that all matter contained in the above description and shown in the accompanying drawings shall be interpreted as illustrative only of particular embodiments and not limiting. Changes in detail or structure may be made without departing from the basic elements of the application as defined in the following claims.

I claim:

1. A method of passive time cost accounting, comprising the steps of:
retrieving standard GPS tracks captured on a mobile device or plurality of mobile devices;
analyzing said standard GPS tracks;
calculating the time a user spent on site as a result of the analysis of said standard GPS tracks.

2. The method of claim 1, wherein the capture of GPS tracks takes place in a passive manner.

3. The method of claim 1 wherein the capture of GPS tracks does not require user intervention.

4. The method of claim 1, wherein the capture of GPS tracks does not require installation of any dedicated hardware into the vehicle to detect motion or engine events.

5. The method of claim 1, wherein the mobile device or plurality of mobile devices collects information to determine standard GPS tracks by utilizing GPS collection tools integrated within the iOS operating system.

6. The method of claim 1, wherein the mobile device or plurality of mobile devices collects information to determine standard GPS tracks by utilizing GPS collection tools integrated within the Android operating system.

7. The method of claim 1, further comprising generating a report of information, wherein said information is viewable on a mobile device or personal computer.

8. The method of claim 1, further comprising generating a report of information, wherein said information is viewable on a mobile device or personal computer, and wherein said information comprises:
the specific times during which a mobile device carried by a worker was stopped throughout the day;
the specific latitude/longitude location at which the mobile device carried by a worker was stopped; and
the duration for which the mobile device carried by a worker was stopped.

9. The method of claim 1, further comprising generating a report of information, wherein said information is viewable on a mobile device or personal computer, and wherein said information comprises:
The duration of a job undertaken by a worker;
the number of side trips taken by the worker to suppliers to complete a job, by cross-referencing the longitude/latitude information collected from a mobile device in the worker's possession against the addresses of suppliers translated into longitude/latitude coordinates through usage of geocoding engines;
the duration of time a worker spends on-site at suppliers; and
the duration of time spent driving to suppliers.

10. The method of claim 1, further comprising generating a report of information, wherein said information is viewable on a mobile device or personal computer, and wherein said information comprises:
the specific times during which a mobile device carried by a worker was stopped throughout the day;
the specific latitude/longitude location at which the mobile device carried by a worker was stopped;
the duration for which the mobile device carried by a worker was stopped.
the duration of a job undertaken by a worker;
the number of side trips taken by the worker to suppliers to complete a job, by cross-referencing the longitude/latitude information collected from a mobile device in the worker's possession against the addresses of suppliers translated into longitude/latitude coordinates through usage of geocoding engines;
the duration of time a worker spends on-site at suppliers;
the duration of time spent driving to suppliers; and
a metric of the overall efficiency of a worker getting a job done.
